(19) United States
(12) Patent Application Publication
(10) Pub. No.: US 2005/0275901 A1
(43) Pub. Date: Dec. 15, 2005

(54) Method of fax machine configuration

(76) Inventors: Christa Ferguson, Round Rock, TX (US); Donald Guthan, Round Rock, TX (US); Charles Morton, Leander, TX (US); Dustin Sorenson, Austin, TX (US)

Correspondence Address: HAMILTON & TERRILE, LLP, P.O. BOX 203518, AUSTIN, TX, 78720, US

(21) Appl. No.: 10/858,264

(22) Filed: Jun. 1, 2004

(51) Int. Cl. H04N 1/00; H04N 1/32

(52) U.S. Cl. 358/400; 358/406; 358/468

(57) ABSTRACT

A method for automatically configuring a customer fax machine which includes establishing a connection between the customer fax machine and a fax machine services provider setup fax machine and sending an encoded setup fax to the customer fax machine. The encoded setup fax provides information to the customer fax machine to automatically configure the customer fax machine based upon fax machine setup information.

### BACKGROUND OF THE INVENTION

1. Field of the Invention

The present invention relates to the field of facsimile devices and more particularly to initializing facsimile devices.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems. One example of an information handing system is a facsimile device.

Setting up a facsimile device (i.e., a fax machine) is often difficult for a consumer and often generates service calls to the provider of the fax machine. This challenge can be exacerbated when the fax machine is provided to a home user or when the fax machine is part of a multifunction device such as a combination printer/fax type of device.

Accordingly, it is desirable to enable automatic configuration of a fax machine for the user. Such an automatic configuration ability would provide a positive customer experience.

### SUMMARY OF THE INVENTION

In accordance with the present invention, a device for enabling automatic configuration of a fax machine is set forth. More specifically, the device for enabling automatic configuration of the fax machine provides users with a number to call using the fax machine, the number then connects the fax machine to a fax machine service provider, the fax machine service provider then configures the fax machine for the customer via the connection between the fax machine and the fax machine service provider. Such a device thus eliminates setup question calls to a fax machine service provider.

When the user receives the fax machine, the user is provided with initial setup instructions which instruct the user to connect the fax machine to a telephone outlet and to dial a predetermined fax machine setup telephone number. When the telephone number is dialed, the fax machine obtains service tag data for the fax machine and then faxes this service tag information to the fax machine service provider.

The service provider includes an auto answer fax machine. The auto answer fax machine includes customer identification information such as caller ID. Using the customer identification information, the fax machine service provider accesses a customer database. The customer database is then searched using either the service tag of the fax machine or the caller ID as a search criteria.

Using the customer identification information and the customer record, the auto answer fax machine faxes back to the customer fax machine an encrypted fax. The automatic configuration module of the customer fax machine interprets the encrypted fax and automatically configures the fax machine accordingly. Upon receipt of the encrypted fax, a page reflecting receipt of the encrypted fax may or may not be printed. Alternately, a display might present configuration information (e.g., informing the customer that the customer fax machine has been configured. If the customer fax machine prints the encrypted page, then after reviewing the configuration information presented on the fax page, the customer simply discards (e.g., recycles) the page.

Such an automatic configuration function reduces access to a fax machine service provider and increases the customer experience of the customer receiving the fax machine. The automatic configuration function is seamless to the customer and eases the setup of a fax machine.

In one embodiment, the invention relates to a method for automatically configuring a customer fax machine which includes establishing a connection between the customer fax machine and a fax machine services provider setup fax machine and sending an encoded setup fax to the customer fax machine. The encoded setup fax provides information to the customer fax machine to automatically configure the customer fax machine based upon fax machine setup information.

In another embodiment, the invention relates to an apparatus for automatically configuring a customer fax machine which includes means for establishing a connection between the customer fax machine and a fax machine services provider setup fax machine and means for receiving an encoded setup fax to the customer fax machine. The encoded setup fax provides information to the customer fax machine to automatically configure the customer fax machine based upon fax machine setup information.

In another embodiment, the invention relates to a fax machine which includes an input/output module and an automatic configuration module coupled to the input/output module. The automatic configuration module establishes a connection between the customer fax machine and a fax machine services provider setup fax machine and receives an encoded setup fax. The encoded setup fax provides information to the customer fax machine to automatically configure the customer fax machine based upon fax machine setup information.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of an environment in which a printer/fax device is used.

FIG. 2 shows a flow chart of the operation of a fax machine automatic configuration module.

### DETAILED DESCRIPTION

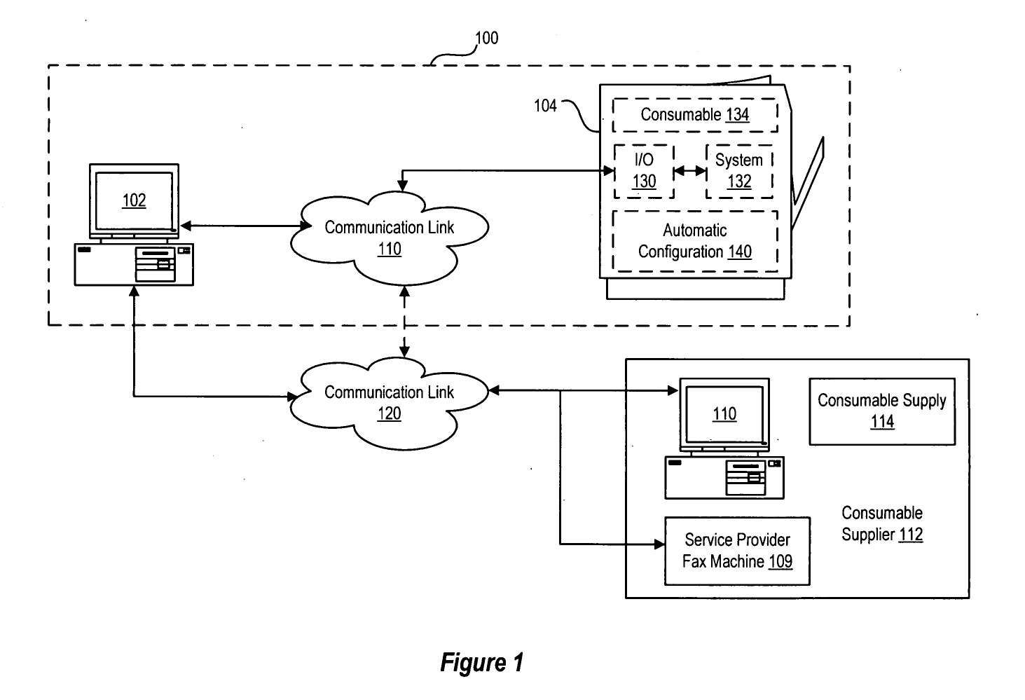

Referring to FIG. 1, a block diagram of an environment in which a fax machine is used is shown. The environment includes a computer system 102 and a fax machine 104, coupled via a communication link 110. The communication link 110 might be a printer cable, a telephone cable, a network connection or any other link which information is communicated with the fax machine 104. In one embodiment, the fax machine is part of a multifunction device such as a combination printer fax machine. Other functions may also be included within the multifunction device such as a scan function and a copy function. Also, in one embodiment, the environment does not include a computer system 102.

The fax machine 104 is coupled to a second communication link 120. Thus, communication may occur between the fax machine 104 and anything coupled to the second communication link 120 such as a services provider fax machine 109. Additionally, the computer system 102 is also connected to another computer system (e.g., a services provider computer system) 110 via a second communication link 120. The second communication link 120 may be a telephone system or some other type of network, such as the Internet. In one embodiment, the fax machine 109 and the computer system 110 are owned and operated by a fax machine service provider 112. In this example, the fax machine service provider 112 provides service for the fax machine 104.

The fax machine 104 includes an input output (I/O) port 130, a control system 132 and at least one consumable 134. The I/O port 130 facilitates communications between the fax machine 104 and other devices connected to the communications link 110. The control system 132 provides the fax machine 104 with certain control functionality. The control system 132 includes a processor and memory coupled to the processor. The fax machine includes an automatic configuration module 140. The automatic configuration module 140 may be stored on either the memory of the fax machine 104 or within the memory of the computer system 102.

The consumable 134 represents any component in the fax machine 104 that is subject to depletion through use of the fax machine 104. For example, the consumable 134 may be a toner cartridge or an inkjet cartridge, etc. The fax machine service provider maintains a supply 114 of replacement consumables 134.

In operation, the fax machine 104 generates documents when receiving a fax via the communication line 120 and the I/O port 130. Additionally, when the fax machine 104 is part of a multifunction device the fax machine may receive and print information from the computer system 102. More specifically, the computer system 102 generates a document in an electronic form and transmits the document (in the form of a print job) to the printer 104. The fax machine 104 receives the job via the I/O port 130 and prints the document.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

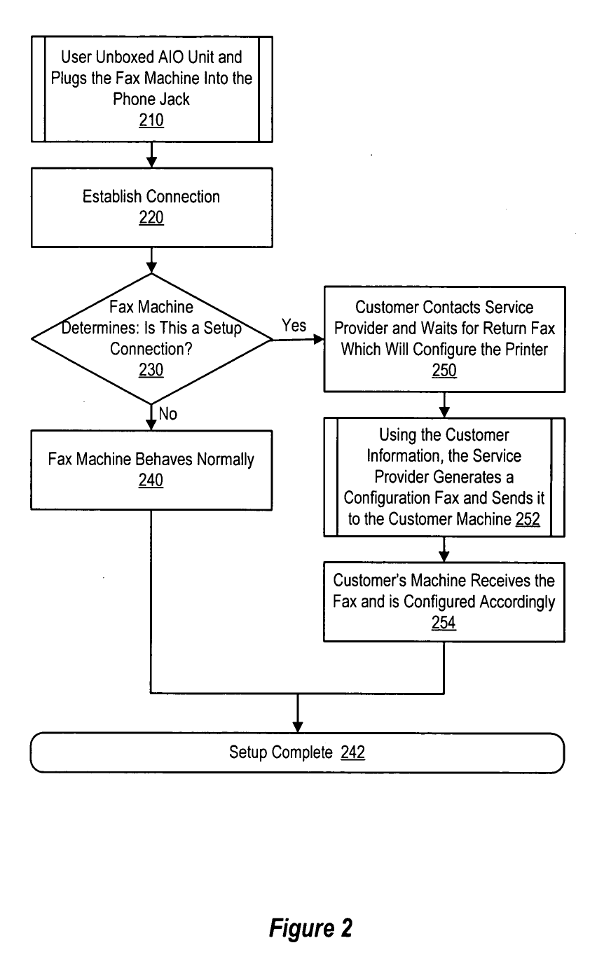

Referring to FIG. 2, the operation of the module 140 for enabling automatic configuration of a fax machine is shown. More specifically, a customer receives and unboxes a fax machine 104. The fax machine 104 includes setup instructions to plug the fax machine 104 into a telephone jack at step 210. The setup information further includes information on how to establish a connection between the fax machine 104 and a fax machine services provider. E.g., this information may include providing the user with a predefined setup number to call using the fax machine. The user then establishes a connection, by e.g., dialing the special configuration fax telephone number with the fax machine, at step 220. The automatic configuration module 140 within the fax machine 104 then determines whether this connection is a setup connection at step 230 by e.g., determining whether the dialed number is the special configuration fax telephone number. If the connection is not a setup connection, then the fax machine 104 functions normally at step 240 and the setup completes at step 242.

If the connection is a setup connection, then the fax machine 104 connects to a service provider fax machine 109. When the connection is established, the fax machine services provider 109 determines customer identification information and the customer fax machine 104 awaits a return fax that will configure the customer fax machine 104 at step 250. The customer identification information may include service tag data for the fax machine 104 or may include caller ID information related to the telephone number from which the customer fax machine 104 established the connection.

The fax machine service provider 112 includes an auto answer fax machine 109. When the auto answer fax machine 109 is connected to the customer fax machine 104, the service provider fax machine 109 obtains customer identification information such as caller ID or the customer fax machine service tag. Using the customer identification information, the fax machine service provider 112 accesses a customer database to obtain configuration information.

The fax machine service provider 112 uses the customer identification information to specifically determine setup information to provide to the customer fax machine 104. The fax machine service provider 112 provides this setup information to the service provider fax machine 109. The service provider fax machine 109 then faxes back to the customer fax machine an encrypted page at step 252. The automatic configuration module 140 of the customer fax machine 104 interprets the encrypted fax and automatically configures the fax machine 104 accordingly. Upon receipt of the encrypted fax, a page reflecting receipt of the encrypted fax may or may not be printed. Alternately, a display on the customer fax machine 104 might present configuration information (e.g., informing the customer that the customer fax machine has been configured. If the customer fax machine 104 prints the encrypted page, then after reviewing the configuration information presented on the fax page, the customer simply discards (e.g., recycles) the page.

The automatic configuration of the customer fax machine could include any information that is automatically provided on a fax sheet or that is presented on a fax cover page such as telephone number, a customer name, a customer address, a customer logo, date and time information etc. In one embodiment, when the customer orders the fax machine, the customer provides information that the customer desires to be presented on the customer fax cover page.

Such an automatic configuration function reduces access to a fax machine service provider and increases the customer experience of the customer receiving the fax machine. The automatic configuration function is seamless to the customer and eases the setup of a fax machine.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Also for example, it will be appreciated that the fax machine service provider and the fax machine supplier could be the same entities or different entities.

Consequently, the invention is intended to be limited only by the spirit and scope of the appended claims, giving full cognizance to equivalents in all respects.

1. A method for automatically configuring a customer fax machine comprising:
establishing a connection between the customer fax machine and a fax machine services provider setup fax machine;
sending an encoded setup fax to the customer fax machine, the encoded setup fax providing information to the customer fax machine to automatically configure the customer fax machine based upon fax machine setup information.

2. The method of claim 1 further comprising:
determining fax machine setup criteria based upon customer identification information.

3. The method of claim 1 wherein:
the customer fax machine is included within a multifunction unit.

4. The method of claim 2 wherein:
the customer identification information includes a customer telephone number.

5. The method of claim 4 further comprising:
determining the customer identification information via a caller identification function.

6. The method of claim 1 further comprising:
determining fax machine identification information; and,
using the fax machine identification information when determining the fax machine setup criteria.

7. The method of claim 6 wherein:
the fax machine identification information includes service tag information.

8. The method of claim 1 wherein:
the establishing a connection includes dialing a configuration telephone number.

9. An apparatus for automatically configuring a customer fax machine comprising:
means for establishing a connection between the customer fax machine and a fax machine services provider setup fax machine;
means for receiving an encoded setup fax to the customer fax machine, the encoded setup fax providing information to the customer fax machine to automatically configure the customer fax machine based upon fax machine setup information.

10. The apparatus of claim 9 further comprising:
means for determining fax machine setup criteria based upon customer identification information.

11. The apparatus of claim 9 wherein:
the customer fax machine is included within a multifunction unit.

12. The apparatus of claim 10 wherein:
the customer identification information includes a customer telephone number.

13. The apparatus of claim 12 further comprising:
determining the customer identification information via a caller identification function.

14. The apparatus of claim 9 further comprising:
means for determining fax machine identification information; and,
means for using the fax machine identification information when determining the fax machine setup criteria.

15. The apparatus of claim 14 wherein:
the fax machine identification information includes service tag information.

16. The apparatus of claim 9 wherein:
the means for establishing a connection includes means for dialing a configuration telephone number.

17. A fax machine comprising:
an input/output module;
an automatic configuration module coupled to the input/output module, the automatic configuration module establishing a connection between the customer fax machine and a fax machine services provider setup fax machine and receiving an encoded setup fax, the encoded setup fax providing information to the customer fax machine to automatically configure the customer fax machine based upon fax machine setup information.

18. The fax machine of claim 17 wherein:
the customer fax machine is included within a multifunction unit.

19. The fax machine of claim 17 wherein:
the fax machine setup information is based upon customer identification information including a customer telephone number.

20. The fax machine of claim 19 wherein:
the customer identification information is determined via a caller identification function.

21. The fax machine of claim 17 further comprising:
fax machine identification information; and,
the fax machine setup information is based upon the fax machine identification information.

22. The fax machine of claim 21 wherein:
the fax machine identification information includes service tag information.

23. The fax machine of claim 17 wherein:
the establishing a connection includes dialing a configuration telephone number.
